(19) United States
(12) Patent Application Publication
(10) Pub. No.: US 2016/0089701 A1
(43) Pub. Date: Mar. 31, 2016

(54) CLEANING MEDIUM SUCTION UNIT AND DRY CLEANING APPARATUS

(71) Applicants: Tadashi KOSUDA, Kanagawa (JP); Akihiro FUCHIGAMI, Kanagawa (JP)

(72) Inventors: Tadashi KOSUDA, Kanagawa (JP); Akihiro FUCHIGAMI, Kanagawa (JP)

(21) Appl. No.: 14/837,440

(22) Filed: Aug. 27, 2015

(30) Foreign Application Priority Data
Sep. 29, 2014 (JP) 2014-198615

(51) Int. Cl. B08B 7/02; B24C 3/06

(52) U.S. Cl. CPC B08B 7/02; B24C 3/065

(57) ABSTRACT

A cleaning medium suction unit is provided. The cleaning medium suction unit includes a container, a vibration plate, a vibration source, and a suction member. The container contains a cleaning medium. The vibration plate is disposed inside the container, and has an upper surface on which the cleaning medium is to be placed. The vibration source vibrates the vibration plate. The suction member is disposed above the upper surface of the vibration plate forming a gap therebetween, and has a suction opening to suck the cleaning medium with a negative pressure.

### CROSS-REFERENCE TO RELATED APPLICATIONS

This patent application is based on and claims priority pursuant to 35 U.S.C. §119(a) to Japanese Patent Application No. 2014-198615, filed on Sep. 29, 2014, in the Japan Patent Office, the entire disclosure of which is hereby incorporated by reference herein.

### BACKGROUND

1. Technical Field

The present disclosure relates to a cleaning medium suction unit and a dry cleaning apparatus using the cleaning medium suction unit.

2. Description of the Related Art

At points of production such as factories producing various parts in large quantities, the parts are delivered and conveyed to points of assembling or processing while being stored in a returnable container typically made of a resin material. Products are also shipped out while being stored in such a returnable container.

Returnable container is one type of material handling, such as hand cart and pallet, which is used to make physical distribution more efficient.

Depending on the type of industry, a large number of returnable containers are constantly used in the factories.

The returnable container generally has a rib structure for improving the strength and therefore has an uneven surface in part. Dirt and dust are likely to attach to and accumulate on such an uneven surface.

Since it is not preferable in terms of quality that such contaminants transfer from the returnable container to parts or products, it is necessary that the returnable container be covered with a lid, or, for more improving quality, is subjected to water washing on a regular basis.

Generally, the contaminants contain viscous dust or clay particle in large amounts, which cannot be removed by a typical dry cleaning process using an air blower.

Viscous contaminants are easily removable when rubbed with finger, however, hardly removable by being blown with a compressed air using an air gun.

This is because viscous contaminants are not resistant to the force parallel to the contaminated surface. Contrary to this property, the air blower acts so as to press the contaminants down.

Washing the returnable container with water, followed by drying, is not an easily-realizable process because of consuming a large amount of time and burdening on workers with a large load. In addition, it greatly burdens on the environment because of discharging water containing detergent in large amounts.

In view of this situation, generally, contaminants are left as they are without being subject to a regular water washing process until the risk of contaminating parts becomes high, and the parts are cleaned after they have been contaminated.

Although the dry cleaning process using an air blower can be performed easily and speedy with a simple equipment, its contaminant-removing efficiency is very low.

### SUMMARY

In accordance with some embodiments of the present invention, a cleaning medium suction unit is provided. The cleaning medium suction unit includes a container, a vibration plate, a vibration source, and a suction member. The container contains a cleaning medium. The vibration plate is disposed inside the container, and has an upper surface on which the cleaning medium is to be placed. The vibration source vibrates the vibration plate. The suction member is disposed above the upper surface of the vibration plate forming a gap therebetween, and has a suction opening to suck the cleaning medium with a negative pressure.

In accordance with some embodiments of the present invention, a dry cleaning apparatus is provided. The dry cleaning apparatus includes a cleaning tank, a compressed air source, a cleaning medium injection member, and the above cleaning medium suction unit. The cleaning tank contains a cleaning target. The cleaning medium injection member is connected to the compressed air source, and injects a cleaning medium toward the cleaning target in the cleaning tank with a compressed air. The cleaning medium suction unit is connected to the cleaning medium injection member, and sucks the cleaning medium fallen down from the cleaning tank owing to a negative pressure generated upon an injection of the compressed air from the cleaning medium injection member and supplies the cleaning medium to the cleaning medium injection member.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A to 1C are schematic plan, elevation, and side views, respectively, of a dry cleaning apparatus in accordance with an embodiment of the present invention;

FIG. 2 is a schematic view illustrating a cleaning medium recycle process in the dry cleaning apparatus;

FIGS. 3A and 3B are plan and side views, respectively, of a cleaning medium in accordance with an embodiment of the present invention;

FIG. 4A is a plan view of a cleaning medium suction unit in accordance with an embodiment of the present invention;

FIGS. 4B and 4C are cross-sectional views taken from line B-B and line C-C, respectively, in FIG. 4A;

FIGS. 5A and 5B are cross-sectional elevation and side views, respectively, illustrating a state where the cleaning medium is sucked;

FIGS. 6A and 6B are cross sectional views illustrating states where the cleaning medium is sucked without and with a vibration plate, respectively;

FIGS. 7A and 7B are plan and side views, respectively, illustrating the direction of movement of the cleaning medium upon vibration of a vibration plate supported at two supporting points;

FIGS. 7C and 7D are plan and side views, respectively, illustrating the direction of movement of the cleaning medium upon vibration of a vibration plate supported at three supporting points;

FIGS. 8A and 8B are a cross-sectional view and a graph, respectively, illustrating a temporal change in amplitude of a vibration plate without foamed urethane;

FIGS. 8C and 8D are a cross-sectional view and a graph, respectively, illustrating a temporal change in amplitude of a vibration plate with foamed urethane;

FIGS. 9A and 9B are elevation and side views, respectively, of a gap adjustment mechanism in accordance with an embodiment of the present invention;

FIG. 10 is a graph showing a relationship among a collection gap, a primary air pressure supplied to an air gun, and a suction injection quantity of the cleaning medium;

FIG. 11 is a cross-sectional view of a connection between a suction pipe and a conveyance pipe in accordance with an embodiment of the present invention;

FIG. 12 is a cross-sectional view of a main part of a buffer material for reducing noise of the vibration plate in accordance with an embodiment of the present invention;

FIG. 13 is a graph showing a relationship between an air supply pressure of an air vibrator and noise of the vibration plate with or without the buffer material; and

FIG. 14 is a flowchart illustrating a procedure for using the dry cleaning apparatus.

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

One object of the present invention is to provide a cleaning medium suction unit which can easily suck a cleaning medium, even in the form of flakes, without causing clogging, to improve dry cleaning performance.

In accordance with some embodiments of the present invention, a cleaning medium suction unit is provided which can easily suck a cleaning medium, even in the form of flakes, without causing clogging, to improve dry cleaning performance.

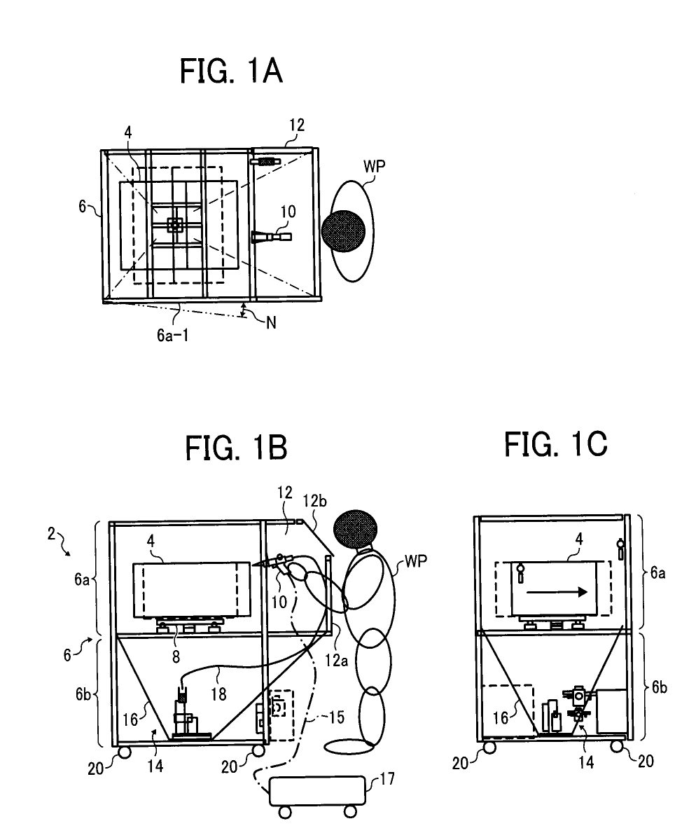

Configuration of a dry cleaning apparatus in accordance with an embodiment of the present invention is described below with reference to FIGS. 1A to 1C.

A dry cleaning apparatus 2 includes a cleaning tank 6 to contain a cleaning target. The cleaning tank 6 includes an upper tank 6a and a lower tank 6b. In the present embodiment, the cleaning target is a returnable container 4 made of a resin material.

The upper tank 6a has a turntable 8 to place the returnable container 4 thereon. A to-be-cleaned surface of the returnable container 4 is easily replaceable with a slight operational force. The turntable 8 may be electronically driven by a predetermined angle.

On one side surface of the upper tank 6a, an operation space 12 is provided in which an operator WP inserts his/her hands to operate an air gun 10 serving as a cleaning medium injection member.

On a front surface 12a of the operation space 12, two insertion holes are provided in which the operator WP inserts his/her hands. Inside the insertion holes, hand covers for protecting the hands are provided.

The operator WP inserts his/her both hands in the insertion holes and performs a cleaning operation while holding the air gun 10 with the covered hands. The air gun 10 is provided at a predetermined position inside the upper tank 6a by, for example, being suspended.

On an upside of the front surface 12a of the operation space 12, a window 12b formed of a transparent material is provided through which the operator WP visually observes the cleaning status in the cleaning tank 6.

The window 12b has an additional function as a protection cover that suppresses a cleaning medium from scattering.

The returnable container 4 can be inserted in the upper tank 6a from any of its side surfaces. In the present embodiment, as illustrated in FIG. 1A, the operator WP opens and closes a left side surface 6a-1 in a direction indicated by arrow N to insert the returnable container 4 therefrom.

In the lower tank 6b, a cleaning medium suction unit 14 serving as a cleaning medium collection unit is provided. The cleaning medium suction unit 14 has a hopper 16 serving as a container to contain a cleaning medium.

The cleaning medium is injected from the air gun 10 toward the returnable container 4, and falls down by its own weight and accumulates on the bottom of the hopper 16.

The air gun 10 is connected to an air compressor 17 serving as a compressed air source through an air hose 15. The air gun 10 injects a compressed air when its lever is operated so as to open a valve.

The air gun 10 and the cleaning medium suction unit 14 are connected to each other through a conveyance pipe 18. Upon injection of the compressed air from the air gun 10, the inner pressure of the conveyance pipe 18 becomes negative. Owing to this negative pressure, the cleaning medium accumulated in the hopper 16 is sucked, and conveyed and supplied to the air gun 10.

The cleaning medium supplied to the air gun 10 is blown toward a to-be-cleaned surface of the returnable container 4 by injection of the compressed air.

The cleaning medium blown toward the to-be-cleaned surface of the returnable container 4 then falls down and accumulates on the bottom of the hopper 16, and re-supplied to the air gun 10.

In particular, the cleaning medium circulates within the cleaning tank 6 by repeatedly subjected to the cycle of: being injected from the air gun 10; coming into collision with the returnable container 4; falling down toward the hopper 16; being sucked by the cleaning medium suction unit 14; and being supplied to the air gun 10.

On the bottom surface of the lower tank 6b, casters 20 are provided to make the dry cleaning apparatus 2 movable anywhere.

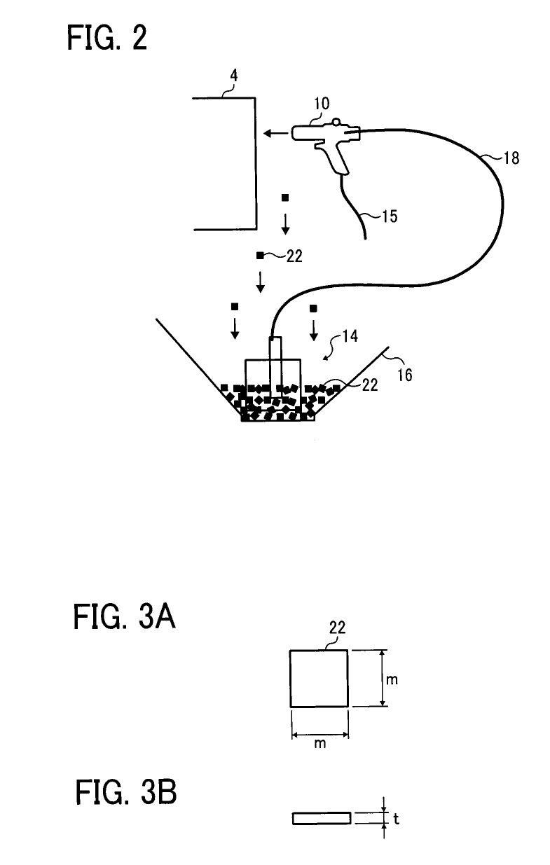

The circulation process of the cleaning medium is described below with reference to FIG. 2. A cleaning medium 22 injected from the air gun 10 comes into collision with a to-be-cleaned surface of the returnable container 4 and then falls down toward the hopper 16.

The cleaning medium 22 accumulates on the bottom of the hopper 16 forming layers thereof. The layered cleaning medium 22 is then sucked by the cleaning medium suction unit 14 with a negative pressure, conveyed through the conveyance pipe 18, and supplied to the air gun 10.

In the present embodiment, the cleaning medium 22 consists of flakes of a polyethylene terephthalate (PET) film having a square shape with each side having a length m of 6 mm a thickness t of 0.05 mm, as illustrated in FIGS. 3A and 3B.

The shape and material of the cleaning medium are not limited thereto, and arbitrarily selected according to the purpose of cleaning.

For example, when one wishes to reduce damage to the cleaning target as much as possible, flakes of resin or paper provide great effect. By contrast, when one wishes to achieve a finishing effect, flakes of metal, ceramic, or biomass such as shell provide great effect.

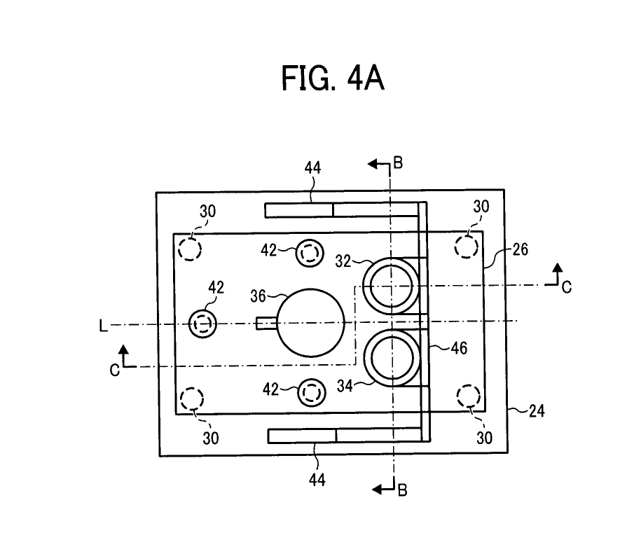

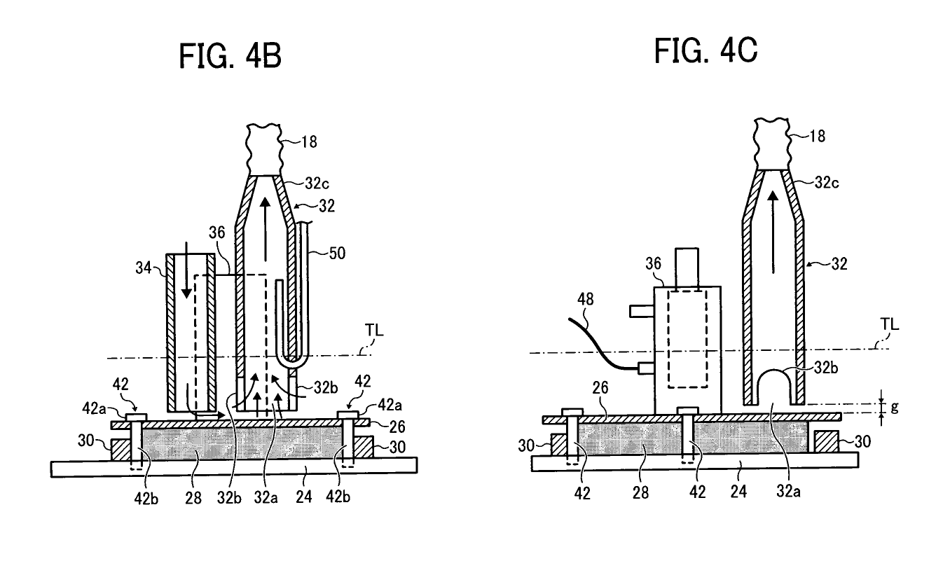

Configuration of the cleaning medium suction unit 14 inside the hopper 16 is described below with reference to FIGS. 4A to 4C.

The cleaning medium suction unit 14 includes a base member 24 to be placed on the bottom surface of the lower tank 6b, a vibration plate 26 disposed on an upper surface side of the base member 24, and a foamed urethane 28 serving as a flexible member sandwiched between the base member 24 and the vibration plate 26.

The upper surface of the vibration plate 26 serves as a surface on which the cleaning medium is to be placed.

The cleaning medium suction unit 14 further includes four lower limit stoppers 30 composed of a rubber that regulate the lower limit of the vibration plate 26. Each of the lower limit stoppers 30 is fixed to the base member 24 at a position corresponding to each of the four corners of the vibration plate 26.

The cleaning medium suction unit 14 further includes a suction pipe 32 serving as a suction member connected to the conveyance pipe 18, an intake pipe 34 serving as an intake member disposed near the suction pipe 32 along one side of the vibration plate 26, and an air vibrator 36 serving as a vibration source.

The air vibrator 36 is disposed on a center line L of the vibration plate 26 near the suction pipe 32 and the intake pipe 34.

The cleaning medium suction unit 14 further includes three upper limit stoppers 42 that regulate the upper limit of the vibration plate 26. Two of the upper limit stoppers 42 are disposed on respective sides of the air vibrator 36 in a direction perpendicular to the center line L, and one of the upper limit stoppers 42 is disposed on an opposite side of the suction pipe 32 relative to the air vibrator 36 on the center line L.

Each of the upper limit stoppers 42 has a flange part 42a and a shaft part 42b. Each of the upper limit stoppers 42 is fixed by inserting the shaft part 42b in the vibration plate 26 from an upper surface side thereof and screwing it with the base member 24.

As the upper surface of the vibration plate 26 comes into contact with the flange part 42a, the upper limit position of the vibration plate 26 is regulated.

The suction pipe 32 and the intake pipe 34 are held by a holder plate 46 supported by a pair of support posts 44 fixed at respective end sides of the base member 24. A collection gap g between the upper surface of the vibration plate 26 and the suction pipe 32 is adjustable, as described in detail later.

The suction pipe 32 has on its lower end a suction opening 32a from which the cleaning medium is sucked. The suction pipe 32 further has two notches 32b, one of which on its side surface facing the intake pipe 34 and the other on the opposite surface thereof, for facilitating a suction.

An upper end 32c of the suction pipe 32, which is connected to the conveyance pipe 18 on a downstream side relative to the direction of suction, is tapered.

When being sucked, the cleaning medium is in the form of a block in part. If such a cleaning medium block is passed through the hoses and pipes as it is, injection of the cleaning medium becomes uneven.

The flow of the cleaning medium, even in a pulsed state, can be equalized at the tapered upper end. Thus, it is possible to stably supply the cleaning medium to the air gun 10 owing to the tapered upper end. In the present embodiment, the air vibrator 36 is capable of performing a piston motion in the vertical direction by pneumatic pressure. Referring to FIG. 4C, a numeral 48 denotes an air hose connected to a compressed intake air source.

The configuration of the air vibrator 36 is not limited thereto. The air vibrator 36 may employ any other vibration means such as a rotor equipped with an eccentric cam.

The air vibrator 36 is not limited to that capable of performing a reciprocating motion in the vertical direction, and may have a rotation mechanism (e.g., ball roller mechanism) or a leaf spring mechanism.

The intake pipe 34 supplies air to the cleaning medium near the suction pipe 32 to loosen layers or blocks of the cleaning medium. The cleaning medium is accumulated on the bottom of the hopper 16 while burying the suction opening of the suction pipe 32.

The upper end of the intake pipe 34 is positioned above an upper surface TL of the layers of the cleaning medium, and is capable of incorporating air from the outside of the layers. The intake pipe 34 is capable of supplying air to the inside of the cleaning medium layers.

Upon generation of a suction airflow within the suction pipe 32 by a negative pressure, the suction action extends to the intake pipe 34 disposed near the suction pipe 32. Thus, air flows from the outside of the layers of the cleaning medium toward a lower end side of the intake pipe 34, and is injected from the lower end of the intake pipe 34 to enter between the layered cleaning media to loosen them.

As illustrated in FIG. 4B, the suction pipe 32 is equipped with an air purge pipe 50 that pumps air from an exterior to an interior of the suction pipe 32. (The air purge pipe 50 is omitted from the drawings other than FIG. 4B for the sake of simplicity.)

The air purge pipe 50 is provided for preventing the cleaning medium from deteriorating in fluidity in the suction pipe 32 caused due to clogging and/or charging.

Specific examples of a purge fluid for the air purge pipe 50 include a compressed air, a neutralization air in which a neutralization ion is mixed, and the like.

The purge fluid is injected from the air purge pipe 50 toward a downstream side relative to the direction of suction of the suction pipe 32.

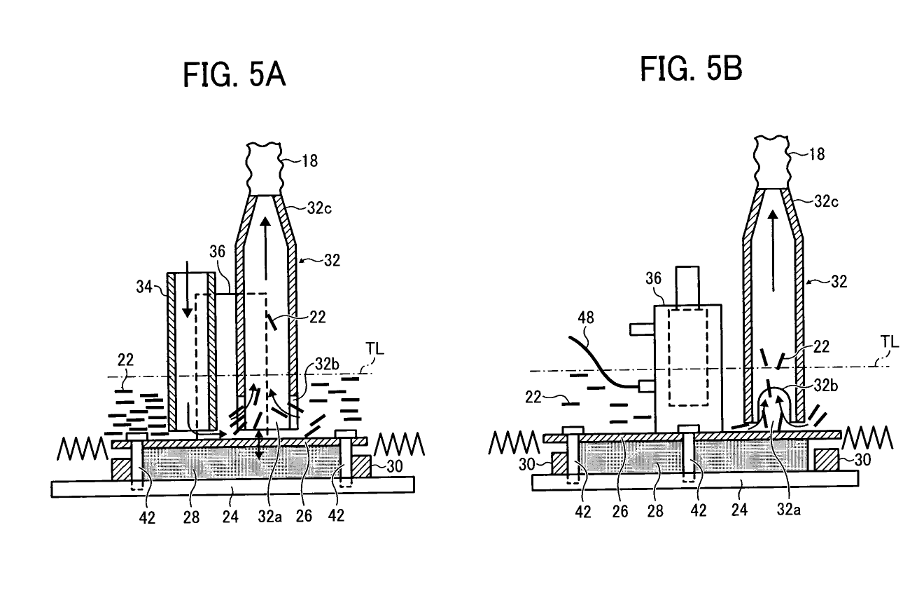

Cleaning medium sucking operation by the cleaning medium suction unit 14 is described below with reference to FIGS. 5A to 5C.

As illustrated in FIG. 5A, flakes of the cleaning medium 22 are randomly laminated on the upper surface of the vibration plate 26.

As air is supplied to the air vibrator 36, the air vibrator 36 starts vibrating at a constant stroke, and the vibration plate 26 vibrates between the upper and lower limits defined by the stoppers.

As the vibration plate 26 vibrates, each flake of the cleaning medium 22 is posture-controlled to transferring from a lying position to a standing position.

The flakes of the cleaning medium 22 are loosened by the air injected from the intake pipe 34 in the process of transferring to a standing position, thereby becoming much easier to fluidize or move in the vertical direction and being sucked in the suction pipe 32. In the absence of the intake pipe 34, the cleaning medium is intermittently injected from the air gun 10.

This is because the cleaning medium in the form of a block repeats the following cycle of: temporarily clogging the suction opening 32a of the suction pipe 32, being destroyed by vibration of the vibration plate 26, and being sucked in the suction opening 32a.

As the intake pipe 34 supplies air to the inside of the layers, the cleaning medium is loosened before reaching the suction opening 32a of the suction pipe 32. Therefore, the suction opening 32a will not be clogged temporarily.

Thus, the cleaning medium is continuously sucked in the suction pipe 32 and continuously injected from the air gun 10.

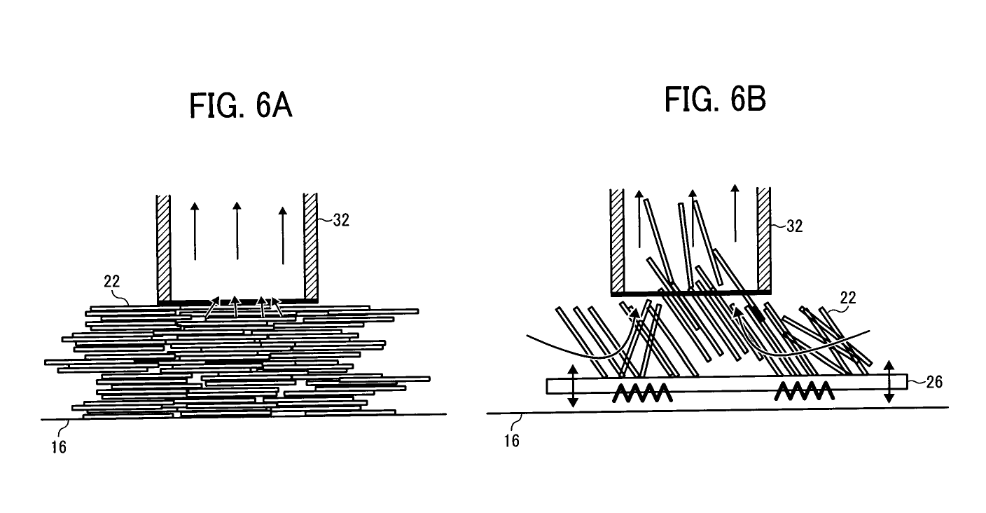

In the absence of the vibration plate 26, i.e., in the case where the cleaning medium accumulated on the bottom of the hopper 16 is directly sucked, the lamination (or block) of the cleaning medium 22 will not fall apart and will clog the suction opening 32a of the suction pipe 32, as illustrated in FIG. 6A.

In the case where the vibration plate 26 is vibrated in the above-described manner, flakes of the cleaning medium 22 change their posture to become much easier to stand up, as illustrated in FIG. 6B. Upon intrusion of air from the intake pipe 34, flakes of the cleaning medium 22 stand up nearly vertical and are sucked in the suction pipe 32.

As flakes of the cleaning medium 22 approach a standing position by vibration, even if only slightly, air passages are formed thereamong that make the flakes more approach a standing position to be easily sucked.

In consideration of this mechanism, the vibration plate 26 can serve as a posture controller that controls the posture of the cleaning medium.

There is a gap having a distance of 1.5 to 2.5 mm between the outer periphery of the shaft part of the each of the upper limit stoppers 42 and the corresponding shaft part insertion hole on the vibration plate 26 so that the vibration plate 26 can keep three-dimensional latitude.

The vibration plate 26 is supported by a plurality of supporting points to be regulated in the vertical direction, but is not fixed by any supporting point. Therefore, the vibration plate 26 can freely move between the shaft part and the insertion hole. The vibration plate 26 is supported by the upper limit stoppers 42 with an allowance in the direction of vibration.

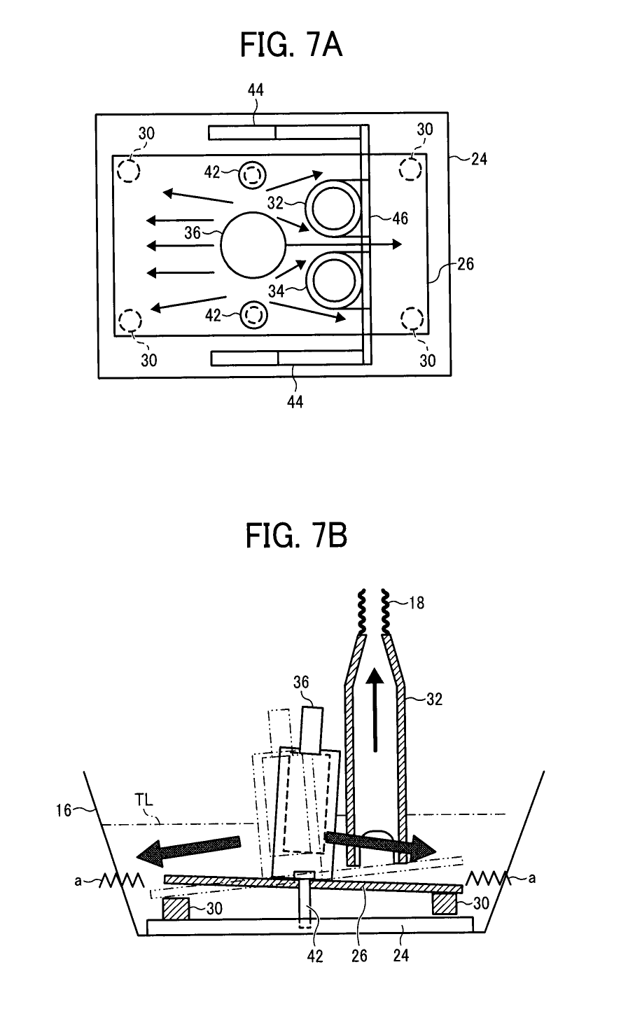

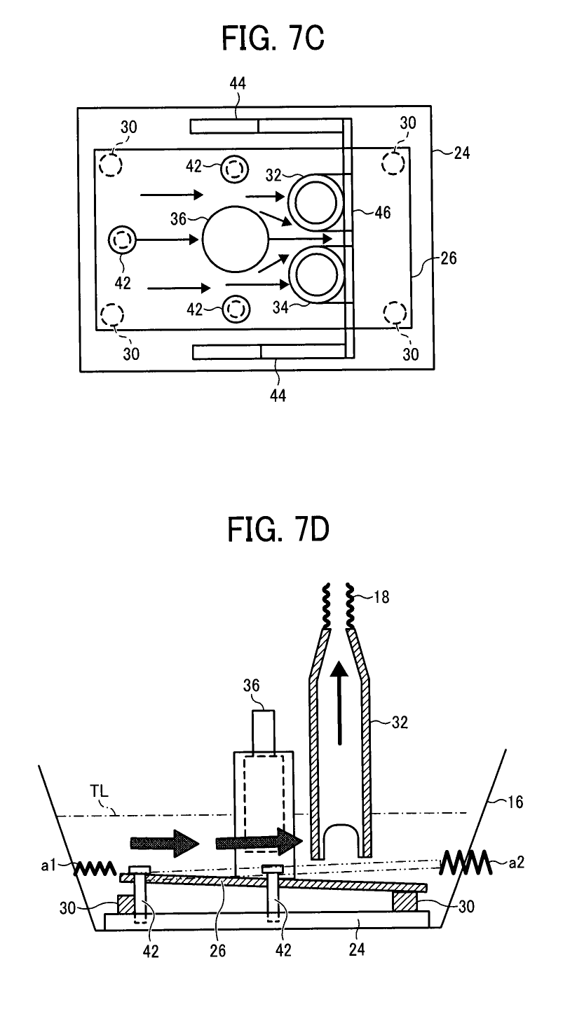

The positional relation between the supporting points of the vibration plate 26 and the air vibrator 36 is described below with reference to FIGS. 7A and 7B.

In the case where the vibration plate 26 is supported by two supporting points (upper limit stoppers 42) facing each other in a radial direction of the air vibrator 36, as illustrated in FIGS. 7A and 7B, an amplitude a of the vibration plate 26 is equal at left and right sides of the air vibrator 36. Therefore, the cleaning medium will move splitting in a direction toward the suction pipe 32 and in the opposite direction thereof.

Accordingly, the efficiency of supply of the cleaning medium to the suction pipe 32 upon vibration is reduced.

By contrast, in the present embodiment, the vibration plate 26 is supported by three supporting points (upper limit stoppers 42) as illustrated in FIGS. 7C and 7D. In this case, amplitudes a1 and a2 of the vibration plate 26 at left and right sides, respectively, are different (a1<a2). Therefore, the cleaning medium will move only in a direction toward the suction pipe 32.

Accordingly, the efficiency of supply of the cleaning medium to the suction pipe 32 upon vibration, as well as the efficiency of suction, is improved.

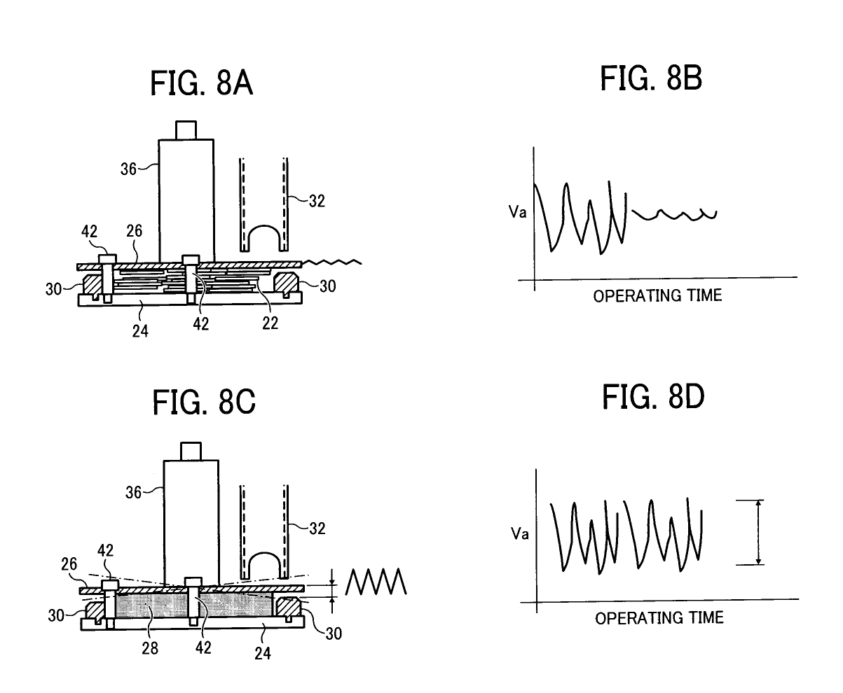

In the case where nothing is disposed in the gap between the base member 24 and the vibration plate 26 as illustrated in FIG. 8A, a vibration amplitude Va becomes smaller as the cleaning medium intrudes the gap near a lower surface side of the vibration plate 26 as illustrated in FIG. 8B.

A smaller vibration amplitude of the vibration plate 26 cannot contribute to standing up of the cleaning medium and will cause clogging of the suction opening 32a of the suction pipe 32, as is the case illustrated in FIG. 6A.

By contrast, in the present embodiment, the foamed urethane 28 is disposed in the gap between the base member 24 and the vibration plate 26 as illustrated in FIG. 8C. Therefore, the cleaning medium is prevented from intruding the gap, and the vibration amplitude Va is kept approximately constant as illustrated in FIG. 8D.

The flexible member is not limited to the foamed urethane 28 so long as it can prevent the cleaning medium from intruding the gap near a lower surface side of the vibration plate 26 and can keep the vibration amplitude Va constant.

The flexible member has a certain degree of hardness that does not reduce vibration repulsion of the oscillator in the air vibrator 36.

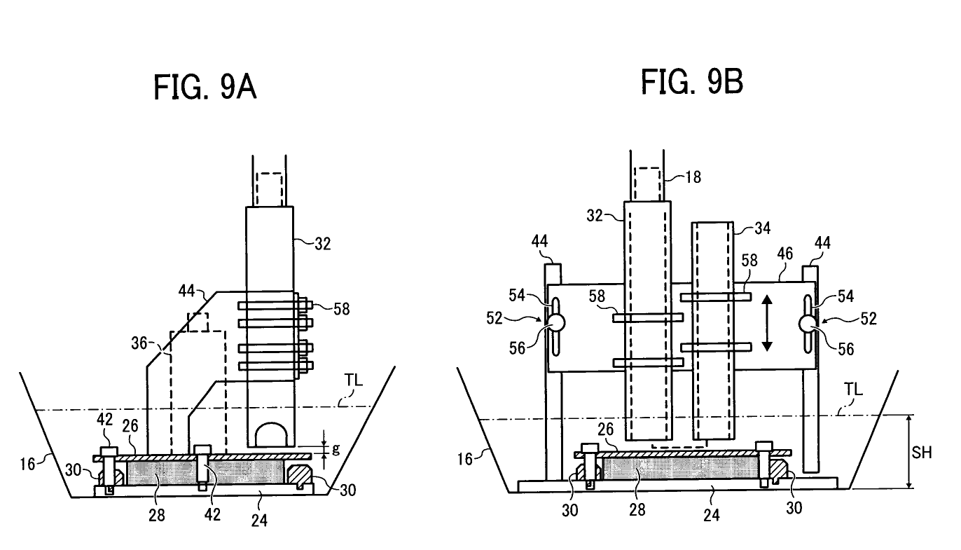

As illustrated in FIGS. 9A and 9B, a gap adjustment mechanism 52 is provided that adjusts the collection gap g between the suction opening 32a of the suction pipe 32 and the upper surface of the vibration plate 26.

The gap adjustment mechanism 52 has slots 54 on both end parts of the holder plate 46 each elongating in a vertical direction, and adjustment screws 56 each screwed with the respective support posts 44 through the respective elongate holes 54.

The collection gap g is adjustable by displacing the holder plate 46 in the vertical direction by loosing and tightening the adjustment screws 56.

In FIGS. 9A and 9B, a numeral 58 denotes a securing member to secure the suction pipe 32 and the intake pipe 34 to the holder plate 46, composed of a U-shaped bolt and a nut.

The difference in height between the bottom surface of the hopper 16 and the upper surface TL of the layers of the cleaning medium serves as a supply height SH of the cleaning medium.

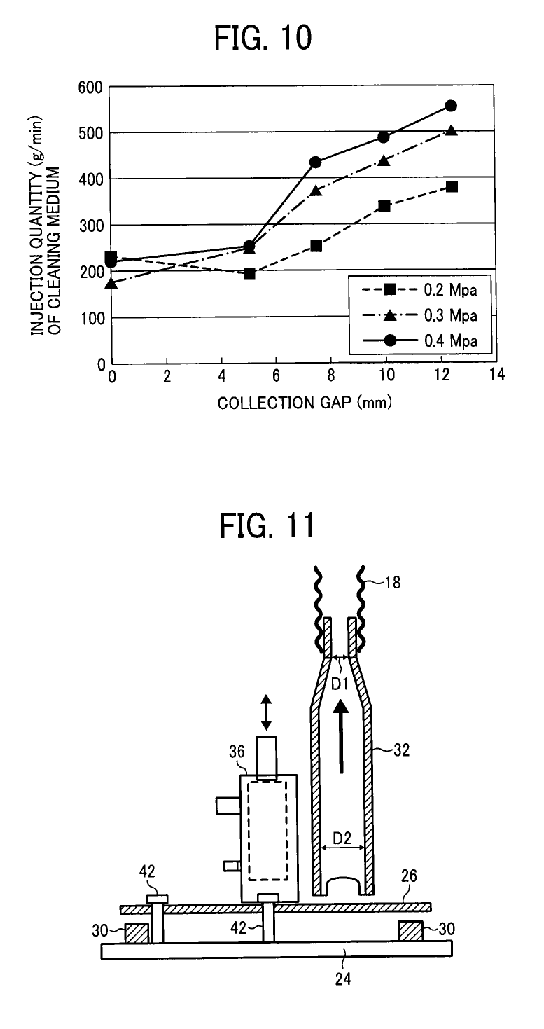

FIG. 10 is a graph showing a relationship among the collection gap g, the compressed air pressure injected from the air gun 10 (primary air pressure), and the quantity of the cleaning medium injected from the air gun 10 per minute.

Detailed data is shown in Table 1.

TABLE 1

| Collection Gap | Primary Air Pressure Supplied to Air Gun (MPa) | | | |
|---|---|---|---|---|
| (mm) | 0.1 MPa | 0.2 MPa | 0.3 MPa | 0.4 MPa |

| | | | |
|---|---|---|---|
| 0 | 228.26 | 176.38 | 219.18 |
| 5 | 192.48 | 250.34 | 252.44 |
| 7.5 | 252.54 | 374.4 | 434.6 |
| 10 | 338.6 | 436.38 | 485.35 |
| 12.5 | 380.5 | 500.38 | 555.35 |

As is clear from FIG. 10 and Table 1, the injection quantity of the cleaning medium increases as the collection gap g increases.

This indicates that the injection quantity of the cleaning medium is variable without varying the primary air pressure supplied to the compressed air source, i.e., without degrading the injection power.

The collection gap g is adjustable within the supply height SH of the cleaning medium. The reason why the injection quantity of the cleaning medium is defined even when the collection gap g is zero is that the suction pipe 32 has the notches 32b at its suction opening.

It is also clear that the injection quantity of the cleaning medium increases as the primary air pressure increases.

This indicates that the injection quantity of the cleaning medium is variable without varying the collection gap g.

Accordingly, it is preferred that an optimum relationship among the type of contaminant, material of the cleaning target, type of the cleaning medium, collection gap g, and primary air pressure is experimentally predetermined and summarized into a table.

By adjusting the collection gap g, primary air pressure, etc., with reference to the table, various contaminants can be effectively removed from the cleaning target while suppressing damage to the cleaning target material.

As illustrated in FIG. 11, the inner diameter of the suction pipe 32 is larger on the suction-opening side and smaller on the conveyance-pipe-18 side.

This is because if the opening diameter of the suction opening is too small, the suction quantity at the time of collecting the cleaning medium becomes unstable.

When the inner diameters of the suction pipe 32 on the conveyance-pipe-18 side and suction-opening side are defined as D1 and D2, respectively, D2 is from 1 to 2 times D2, preferably 1.5 times D2.

The configuration of the suction pipe 32 on the conveyance-pipe-18 side is omitted from the drawings other than FIG. 11 for the sake of simplicity.

The foamed urethane 28 is omitted from FIG. 11 for the sake of simplicity.

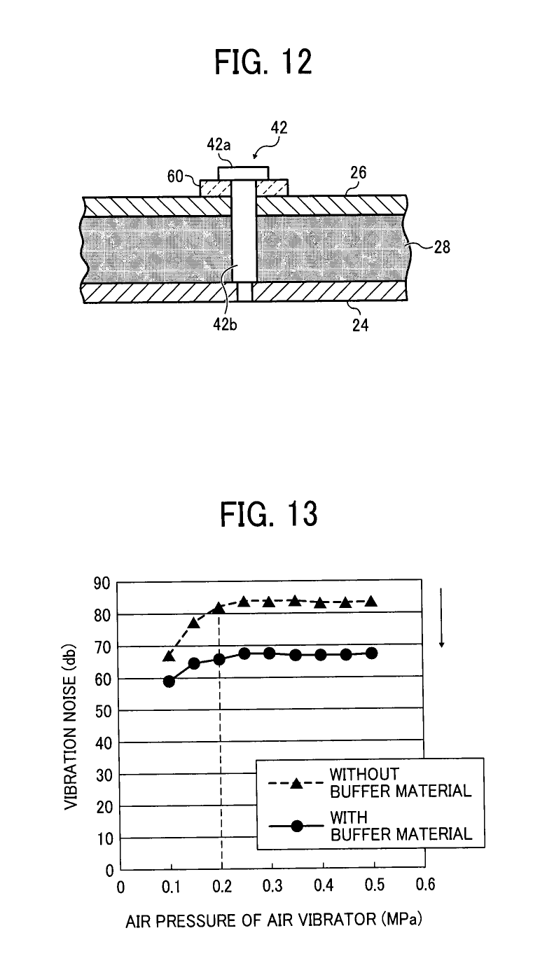

Configuration of a dry cleaning apparatus in accordance with another embodiment of the present invention is described below with reference to FIGS. 12 and 13.

For the sake of simplicity, the same reference number will be given to identical constituent elements such as parts and materials having the same functions and redundant descriptions thereof omitted unless otherwise stated.

As described above, the vibration plate 26 repeats displacing downward by a pressing force from the air vibrator 36 and returning upward by an elastic force of the foamed urethane 28 to generate vibration.

When returning upward, the vibration plate 26 comes into contact with the flange parts 42a of the upper limit stoppers 42 with generating a contact noise.

The contact noise is preferably as small as possible since it possibly becomes a usage environmental noise of the dry cleaning apparatus 2.

According to the present embodiment, the contact noise is more reduced to contribute to reduction of a usage environmental noise of the dry cleaning apparatus 2.

In the present embodiment, as illustrated in FIG. 12, a washer 60 is provided between the upper surface of the vibration plate 26 and the lower surface of the flange part 42a of each of the upper limit stoppers 42. The washer 60 is composed of an urethane rubber and serves as a buffer material.

FIG. 13 shows an experimental result for the relationship between the air supply pressure of the air vibrator 36 and noise of the vibration plate 26 with or without the buffer material.

Detailed data is shown in Table 2.

In the experiment, a noise meter is set on the upper surface of the turntable 8 in the upper tank 6a.

TABLE 2

| Air Supply | With Cleaning Medium | |
|---|---|---|
| Pressure of Air | Noise (db) without Buffer | Noise (db) with Buffer |
| Vibrator (MPa) | Material | Material |
| 0.1 | 67.4 | 58.6 |
| 0.15 | 77.5 | 64.1 |
| 0.2 | 82 | 65.4 |
| 0.25 | 84 | 67.6 |
| 0.3 | 84.3 | 67.5 |
| 0.35 | 84 | 67.1 |
| 0.4 | 83.4 | 67 |
| 0.45 | 83.5 | 66.8 |
| 0.5 | 83.6 | 67.5 |
| Background Noise | 55 | 55.6 |

It is clear from FIG. 13 that the provision of the buffer material reduces vibration noise.

Referring to Table 2, for example, when the air supply pressure is 0.2 MPa, the vibration noise with the buffer material is 16.6 db lower than that without the buffer material.

Namely, the presence of the washer 60 composed of an urethane rubber contributes to reduction of the noise by nearly 20%. The material type of the buffer material is not limited to an urethane rubber.

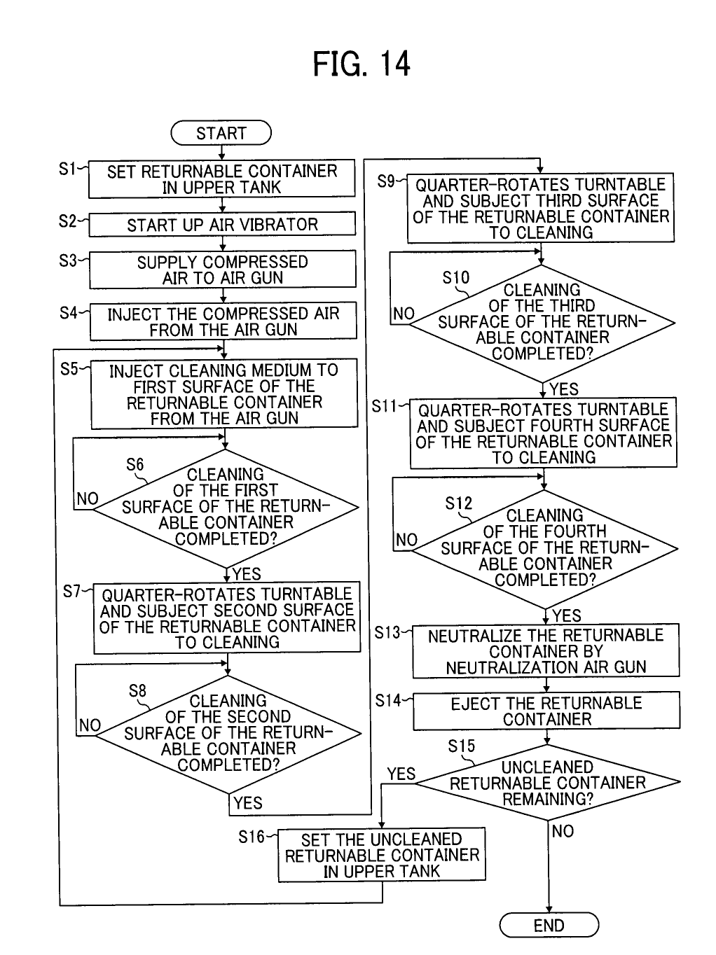

A procedure for using the dry cleaning apparatus 2 is described below with reference to a flowchart illustrated in FIG. 14.

First, the front door of the upper tank 6a is opened, the returnable container 4 is set on the turntable 8, and the door is closed (S1).

Next, the air vibrator 36 is started up, and the air purge pipe 50 is put into a state ready for injecting the purge air (S2).

As the air vibrator 36 is started up, the cleaning medium moves to the periphery of the suction pipe 32 by vibration. Next, a compressed air is supplied to the air gun 10 (S3).

The compressed air is injected from the air gun 10 by pulling the lever of the air gun 10 (S4). Upon injection of the compressed air from the air gun 10, the inner pressure of the conveyance pipe 18 becomes negative, and the cleaning medium is sucked from the suction pipe 32 and injected from the air gun 10 toward the first surface of the returnable container 4 (S5).

The operator WP visually checks whether cleaning of the first surface of the returnable container 4 has been completed or not (S6). When it is determined that the cleaning has been completed, the turntable 8 is quarter-rotated, and the second surface of the returnable container 4 is subjected to cleaning (S7).

The operator WP checks whether cleaning of the second surface of the returnable container 4 has been completed or not (S8). When it is determined that the cleaning has been completed, the turntable 8 is quarter-rotated, and the third surface of the returnable container 4 is subjected to cleaning (S9).

The operator WP checks whether cleaning of the third surface of the returnable container 4 has been completed or not (S10). When it is determined that the cleaning has been completed, the turntable 8 is quarter-rotated, and the fourth surface of the returnable container 4 is subjected to cleaning (S11).

The operator WP checks whether cleaning of the fourth surface of the returnable container 4 has been completed or not (S12). When it is determined that the cleaning has been completed, the first to fourth surfaces of the returnable container 4 are neutralized by a neutralization air gun preset in the upper tank 6a (S13).

This neutralization operation is for removing the cleaning medium electrostatically attached to the surfaces of the returnable container 4, and is not necessary when no cleaning medium is attached.

Upon completion of the neutralization, the cleaned returnable container 4 is ejected from the upper tank 6a (S14). Next, the operator WP determines whether an uncleaned returnable container is remaining or not (S15). When there is a remaining uncleaned returnable container, the uncleaned returnable container is in the upper tank 6a (S16).

When there is no remaining uncleaned returnable container, the procedure is completed.

In the above-described embodiments, the cleaning medium is sucked owing to a negative pressure generated by injecting a compressed air from the air gun 10. Alternatively, the cleaning medium may be sucked and injected by generating an airflow by a blower.

In the above-described embodiments, the cleaning operation is a manual procedure in which the operator WP handles the air gun 10 while visually checking the cleaning status. Alternatively, the cleaning operation may be an automatic procedure in which at least one of the cleaning target and the cleaning medium injection member is mechanically moved to automatically clean the cleaning target.

In the above-described embodiments, the cleaning medium suction unit 14 is used as a collection unit through the cycle of supplying the cleaning medium accumulated in the hopper 16 to the air gun 10. Alternatively, the cleaning medium suction unit 14 is used as a supply unit that supplies the cleaning medium from the container to other parts.

In the above-described embodiments, the cleaning medium suction unit 14 is disposed within the cleaning tank. Alternatively, the cleaning medium suction unit may have another configuration which can suck the cleaning medium fallen down in the cleaning tank and collected at an outside of the cleaning tank by a chute, and supply it to the air gun 10.

What is claimed is:

1. A cleaning medium suction unit, comprising:
a container to contain a cleaning medium;
a vibration plate disposed inside the container, having an upper surface on which the cleaning medium is to be placed;
a vibration source to vibrate the vibration plate;
a suction member disposed above the upper surface of the vibration plate forming a gap therebetween, having a suction opening to suck the cleaning medium with a negative pressure.

2. The cleaning medium suction unit according to claim 1,
wherein the cleaning medium is contained in the container forming layers thereof while burying the suction opening, and
wherein the vibration plate is capable of vibrating in a height direction of the container.

3. The cleaning medium suction unit according to claim 2, further comprising:
an intake member disposed near the suction member, capable of supplying air to an inside of the layers of the cleaning medium.

4. The cleaning medium suction unit according to claim 3, wherein the intake member is capable of supplying air from an outside of the layers in the container to the inside of the layers owing to a suction action of the suction member.

5. The cleaning medium suction unit according to claim 1, wherein the vibration plate is supported by a plurality of supporting point, each of the supporting points having each positional relation with the vibration plate so that the cleaning medium placed on the vibration plate moves toward the suction member upon vibration of the vibration plate.

6. The cleaning medium suction unit according to claim 1, wherein the vibration plate has a flexible member on a lower surface thereof, the flexible member preventing the cleaning medium from entering a lower surface side of the vibration plate.

7. The cleaning medium suction unit according to claim 1,
wherein the vibration plate is supported by a plurality of supporting points with an allowance in a direction of vibration,
wherein the vibration plates has a flexible member on a lower surface thereof, the flexible member preventing the cleaning medium from entering a lower surface side of the vibration plate,
wherein each of the supporting points has a stopper to regulate an upper limit of an amplitude of the vibration plate, and
wherein a buffer materials is disposed between the stopper and the upper surface of the vibration plate.

8. The cleaning medium suction unit according to claim 1, wherein the suction member is tapered toward a downstream side relative to a direction of suction.

9. The cleaning medium suction unit according to claim 1, further comprising:
a gap adjustment mechanism to adjust a gap between the suction opening of the suction member and the upper surface of the vibration plate.

10. A dry cleaning apparatus, comprising:
a cleaning tank to contain a cleaning target;
a compressed air source;
a cleaning medium injection member connected to the compressed air source, to inject a cleaning medium toward the cleaning target in the cleaning tank with a compressed air; and
the cleaning medium suction unit according to claim 1 connected to the cleaning medium injection member, to suck the cleaning medium fallen down from the cleaning tank owing to a negative pressure generated upon an injection of the compressed air from the cleaning medium injection member and supply the cleaning medium to the cleaning medium injection member.
